(19) United States
(12) Patent Application Publication
(10) Pub. No.: US 2010/0303404 A1
(43) Pub. Date: Dec. 2, 2010

(54) TRANSDUCER WITH MULTIMODAL OPTICAL FIBRE AND MODE COUPLING AND METHOD FOR MAKING SAME

(75) Inventor: Sylvain Fischer, Strasbourg (FR)

Correspondence Address: YOUNG & THOMPSON, 209 Madison Street, Suite 500, Alexandria, VA, 22314, US

(73) Assignee: PHOSYLAB, Bischwiller (FR)

(21) Appl. No.: 12/680,303

(22) PCT Filed: Sep. 26, 2008
(86) PCT No.: PCT/FR08/51723

§ 371 Date: Mar. 26, 2010

(30) Foreign Application Priority Data
Sep. 26, 2007 (FR) 0757883

(51) Int. Cl. G02B 6/00; G02B 6/26

(52) U.S. Cl. 385/13; 65/406

(57) ABSTRACT

An optical fibre transducer is sensitive to at least one parameter of an environment in which it is located, the modification of the parameter(s) resulting in a modification of at least one measurable characteristic of a light wave injected into the optical fibre and flowing through the transducer, the optical fibre being multimodal and including an element adapted so that the modification of the light wave characteristic is based on a modification of mode coupling resulting from the modification of the environment parameter, the element leading to a mode coupling modification that generates, during the modification, a deformation of the optical fibre in the transducer according to a predetermined pattern. The element leading to the mode coupling modification is a hollow tube containing a relief pattern and surrounding the optical fibre at the transducer in a straight part of the fibre.

The present invention relates to multimode optical fibre transducer with mode coupling. It finds applications in the field of metrology.

The optical fibre sensors have been the subject of numerous investigations for many years. Multimode optical fibre solutions with mode coupling have been studied in laboratory and the development of components such as the fibre Bragg grating has allowed the design of very precise optical fibre sensors that can be multiplexed into large scale gratings, notably for the monitoring of structures in civil engineering (bridges, tunnels, etc.). The fibre Bragg grating is a component that is sensitive to the temperature, to the longitudinal deformation along its cylindrical symmetry axis, and finally to the pressure. Therefore, such component is an extremely versatile element that, when integrated in appropriate transduction mechanisms, is well adapted to the measurement of very numerous physical and chemical parameters, while providing the thus developed sensors with the added values of measurement by optical techniques. However, the Bragg grating technology remains very expensive.

On the other hand, the multimode optical fibre sensors have become competitive, notably because their methods of manufacturing admit much larger tolerances than the monomode optical fibre technologies.

The object of the present invention is to provide a multimode optical fibre component that is sensitive to (at least) the temperature, the longitudinal deformation along the cylindrical symmetry axis of the fibre and the pressure, while being very cheap. Furthermore, with the invention, it becomes possible to use the transduction mechanisms already developed for the fibre Bragg gratings.

Hereinafter, the parameter to be measured in the environment will be referred to as the “measurand”.

Accordingly, the invention relates to an optical fibre transducer, said transducer being sensitive to at least one parameter (also referred to as the “measurand”) of an environment in which it is placed, the modification of the parameter(s) resulting in a modification of at least one measurable characteristic of a light wave injected into the optical fibre and flowing through the transducer, the optical fibre being of the multimode type and including a means adapted so that the modification of the light-wave characteristic depends on a modification of mode coupling resulting from the modification of the environment parameter, the means leading to the mode coupling modification generating, upon the modification, a deformation of the fibre in the transducer according to a determined pattern.

According to the invention, the means leading to the mode coupling modification is a hollow tube including therein a relief pattern and enclosing the optical fibre at the level of the transducer, in a straight part of the fibre.

In various embodiments of the invention, the following means may be used, either alone or in any technically possible combination:
the mode coupling modification is furthermore due to a modulation of the numerical aperture of the fibre (the refractive indices of the core and of the optical cladding have different variation coefficients),
the deformation is a set of micro-curvatures generating a coupling of the fibre modes, without structural transformation of the fibre modes,
the deformation is an isotropic spatial modulation of the fibre diameter generating a coupling of the fibre modes, without structural transformation of the fibre modes,
the deformation is an anisotropic spatial modulation of the fibre diameter,
the deformation is a spatial modulation of the fibre diameter,
the deformation varies as a function of the variation of the environment parameter,
the deformation through spatial modulation of the fibre diameter varies in diameter (variable narrowings of the fibre, especially under the effect of radial forces/pressures onto the tube) as a function of the variation of the environment parameter,
the deformation through spatial modulation of the fibre diameter varies in frequency (the position of the deforming patterns varies, especially under the effect of axial/longitudinal forces/pressures onto the tube) as a function of the variation of the environment parameter,
the hollow tube including therein a relief pattern and enclosing the optical fibre at the level of the transducer applies a stress to said fibre at rest, said fibre being deformed according to the determined pattern at rest (=pre-disturbance/pre-movement . . . , the rest state corresponds to the basal state of the parameter, either it has no action on the transducer, or this action corresponds to a state considered as a basal state),
the hollow tube including therein a relief pattern and enclosing the optical fibre at the level of the transducer does not apply any stress to said fibre at rest, said fibre being not deformed at rest (the rest state corresponds to the basal state of the parameter, either it has no action on the transducer, or this action corresponds to a state considered as a basal state),
the tube is made of two longitudinal parts closing onto the fibre,
the tube is made of two longitudinal parts that can be separated from each other at least in the region of the transducer comprising the relief pattern (the two parts acting as a clamp that can be tightened to the fibre or released),
each longitudinal part comprises, at at least one of its two longitudinal ends, an extension acting as an elastic lever arm enabling the corresponding part to be brought back to a rest position in the absence of action from the environment parameter(s), said extension having no influence on the light-wave characteristics (the rest state corresponds to the basal state of the parameter, either it has no action on the transducer, or this action corresponds to a state considered as a basal state),
each longitudinal part comprises, at each of its two longitudinal ends, an extension acting as an elastic lever arm enabling the corresponding part to be brought back to a rest position in the absence of action from the environment parameter(s), said extension having no influence on the light-wave characteristics (the rest state corresponds to the basal state of the parameter, either it has no action on the transducer, or this action corresponds to a state considered as a basal state),
each longitudinal part is an elongated straight semi-cylinder,
the tube is made of two longitudinal parts united and fastened together,
the two longitudinal parts are fastened together by welding, gluing, crimping or clipsage,
at least one of the two parts includes therein the relief pattern,
the relief pattern comprises crests and valleys, whose amplitude and spatial distribution are chosen as a function of at least one of the environment parameters and of the light-wave measured characteristic(s),
the environment parameter is chosen from one or more of the following possibilities:
   force by deformation of the tube,
   force by radial pressure or traction on the tube,
   force by longitudinal pressure or traction on the tube,
   temperature,
the light-wave measured characteristic is chosen from one or more of the following possibilities:
   attenuation of the light wave flowing through the transducer,
   phase shifting of the light wave flowing through the transducer,
the optical fibre comprises an inner core and an outer optical cladding,
the optical fibre further comprises an outer coating,
the tube is placed on the outer coating of the optical fibre,
the outer coating of the optical fibre is removed at the level of the transducer, the tube being placed around the optical cladding of the fibre,
the core and the optical cladding of the fibre are made of glass,
the glass of the optical cladding is doped,
the outer coating is a mechanical cladding,
the mechanical cladding is made of polyimide,
the tube is made of aluminum.

The invention also relates to a method for making an optical fibre transducer, such that for a transducer according to one or more of the described characteristics and having a relief pattern inside a hollow tube enclosing the fibre and modifying the coupling of guided and/or radiated modes as a function of at least one parameter acting by deformation on said transducer, the pattern is determined based on a spatial spectrum of disturbance as a function of the modes to be coupled for the type of deformation anticipated for the parameter to be measured. The method may be adapted according to the various described ways.

The present invention will now be illustrated, without being limited thereby, in the following description, with reference to the appended drawings, in which:

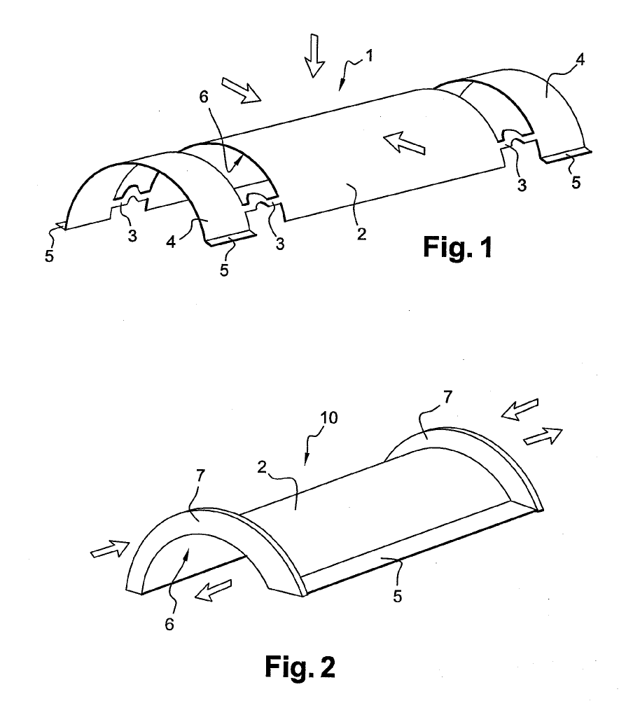

FIG. 1 schematically shows one of the two parts of an exemplary tube for a transducer with radial forces according to the invention, wherein the different elements constituting it are not in scale,

FIG. 2 schematically shows one of the two parts of an exemplary tube for a transducer with axial forces according to the invention, wherein the different elements constituting it are not in scale,

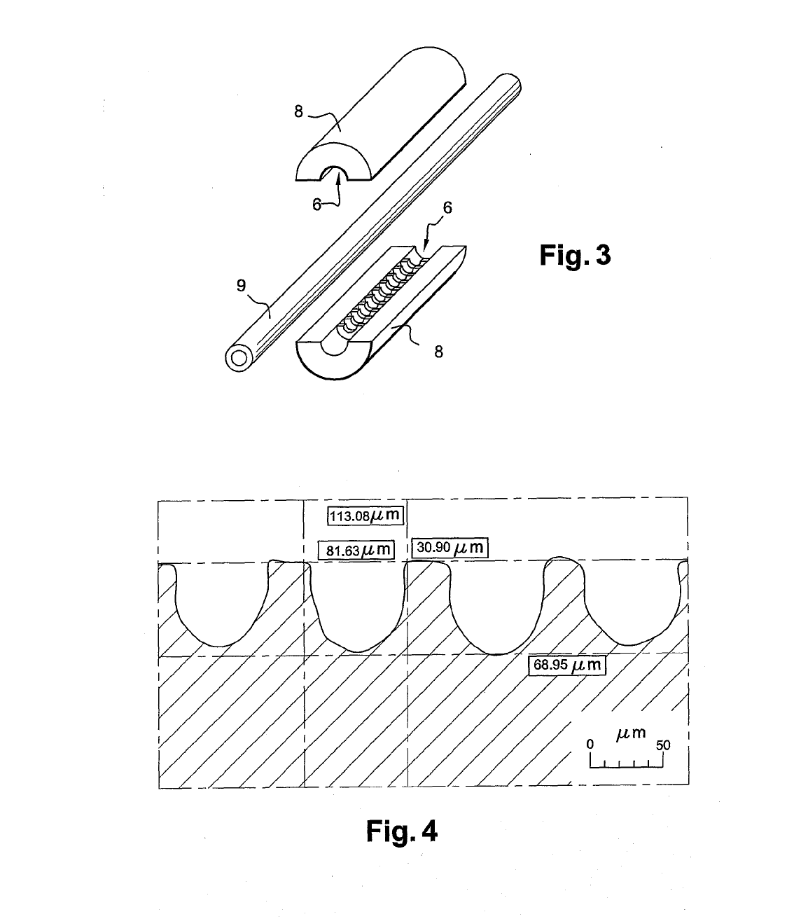

FIG. 3 schematically shows an exploded view of a transducer, wherein the two parts of a patterned tube are separated from the optical fibre and from each other, and

FIG. 4 is an enlarged cross-sectional view of a patterned tube, taken at a patterning so as to show a portion of an exemplary relief pattern.

In a first part, the general principles underlying the invention will now be disclosed with reference to the general means implemented to achieve the making of a transducer according to the invention.

In a second part, a more detailed description of implementation and exemplary embodiments will be disclosed.

An optical fibre is a waveguide, i.e. a medium capable of guiding a wave signal that propagates along an axis, which is the cylindrical symmetry axis of the fibre and which is called the “propagation axis” of the fibre. The fibre, in its simplest version, is made of a core and an optical confinement cladding, referred to as the “cladding”. The optical properties of the core and the cladding are slightly different so that any signal coupled to an end of the fibre perceives two different speeds of propagation between the core and the cladding. The cladding may be made of a material very similar to that of the core, or it may be air or vacuum. The refractive index of the core has only to be higher than that of the cladding. It is to be noted that the fibre is often surrounded with an outer coating intended to provide it with a mechanical protection, wherein the coating sometimes merges with the cladding.

If the optical signal satisfies the fibre guiding conditions, as determined by the refractive indices of the core and the cladding with respect to the wavelength of the signal, a part of the energy of the signal is confined in the fibre core and remains in the cladding near the core. In the ideal case (a perfect and non-absorbent medium), the energy of the signal is transmitted from the end where the signal enters into the fibre to the end where signal exits from the fibre, without loss (without attenuation). The signal is said to be guided.

If the signal does not satisfy the fibre guiding conditions, the signal may propagate along the axis of the fibre (its energy is distributed without confinement between the core and the cladding), but its energy is entirely transmitted to the cladding and to the outer environment of the fibre after a certain distance covered by the signal along the fibre axis. The energy is said to be radiated far from the fibre and the signal is said to be radiating or to be radiated.

The fibre is said to be multimode if there exist in this fibre several different ways for a signal coupled to the fibre (injected into the fibre) to be guided and thus to propagate along the fibre. These different ways of guiding and propagation are referred to as the “guided modes” of the multimode fibre.

The guided modes of a fibre constitute a finite and discrete set. The guided modes are indexed according to their group order (index m). Each group of guided modes includes the guided modes with the same value of propagation constant (the propagation constant is a measure of the distance between two points along the propagation axis at which the mode phase is the same, modulo 2π). The propagation constant value of each group of guided modes of index m is lower than the propagation constant value of the groups of guided mode with an index lower than m. The propagation constant value of all the guided modes is lower than the value of the wave vector the signal would have if propagating in a medium similar to that of the fibre core but without a guiding structure (free propagation). The propagation constant value of all the guided modes is higher than the value of the wave vector the signal would have if propagating in a medium similar to that of the fibre cladding but without a guiding structure. Therefore, the groups of guided modes may be ordered: the guided modes of the group of order 1 have the highest propagation constant, whereas the guided modes of the group of the highest order M have the lowest propagation constant. In practice, M is thus the number of groups of guided modes in the fibre.

The radiated modes form a continuous and bounded set. They are indexed by the value of their propagation constant, which value is comprised between 0 and the value of the wave vector the signal would have if propagating in a medium similar to that of the fibre cladding but without a guiding structure. The value of their propagation constant is thus lower than the value of the propagation constant of all the guided modes.

It is to be noted that still other modes exist, for example evanescent modes, but they are not relevant in the framework of the present invention.

When a multimode fibre is subjected to a disturbance, propagation modes of the optical signal may exchange energy with each other, wherein a disturbance causes a structural modification of modes all along the disturbed segment of the fibre. In this case, the modes are said to be coupled. Such energy exchanges can be modeled as a function of coupling coefficients that quantify the magnitude of the energy exchange between the modes all along the disturbed segment of the fibre.

Therefore, a disturbance causes the coupling between the guided modes, between the radiated modes, and between the guided modes on the one hand and the radiated modes on the other hand. It results from this latter type of coupling that there exists a leakage of energy from the guided modes (whose energy is in the ideal case partially confined in the core, guided and without attenuation) to the radiated modes (whose energy is not confined, not even partially, in the core of the guide and is radiated toward the outer environment of the fibre). Therefore, the guided modes undergo a loss of energy and thus an attenuation of their energy. The guided modes are said to be absorbent (provided that nothing in the environment of the fibre—including the tube or the possible mechanical cladding—couples again the radiated energy in the core of the fibre).

Beyond a certain distance determined by the characteristics of the fibre and of the disturbance applied, the guided modes have lost all their energy. This distance is peculiar to each guided mode and is referred to as the effective length of attenuation thereof.

Still according to the theory of disturbance of a fibre, if the spectrum in the space of the spatial frequencies (the spatial spectrum) of the disturbance is limited to the spectrum components whose value is lower than a value defined by the characteristics of the fibre, the disturbance does not stimulate any coupling between the modes of the fibre. If the values of the spectrum components are higher than this value but lower than a higher value also determined by the characteristics of the fibre, the disturbance stimulates the coupling between certain guided modes of the fibre. Finally, if the value of the spectrum components is higher than this second value, the disturbance stimulates the coupling between certain guided modes on the one hand and certain radiated modes on the other hand.

The spatial spectrum of the disturbance may be synthesized to stimulate the coupling between some/all of the guided modes or between some/all of the guided modes on the one hand and some/all of the radiated modes on the other hand.

In case of an indirect coupling, from guided modes to guided modes, if the spatial spectrum of the disturbance is limited to the spectrum components that stimulate the coupling between guided modes, the analysis of the disturbance of a guide nevertheless anticipates that these modes are absorbent. Consequently, the stimulation of the coupling between all the guided modes up to the guided modes of the group of order m allows the leakage of energy from all these modes of order lower than m toward the modes of the group of order m, wherein these latter, being absorbent, cause the loss of energy from all these modes beyond its effective attenuation distance. This coupling via a chosen group of absorbent guided modes is an indirect coupling of the energy. It requires spectrum components whose value is higher than the value of the spectrum components that couple the guided modes to the radiated modes. Finally, the loss (attenuation) rate of this coupling is exactly m/M.

In the case of a direct coupling, from guided modes to radiated modes, if the spatial spectrum of the disturbance is limited to the spectrum components that stimulate the coupling between guided modes on the one hand and radiated modes on the other hand, the energy leakage of the guided modes is then direct. This coupling requires spectrum components whose value is lower than the value of the spectrum components that couple the guided modes together.

It is deduced therefrom that it is possible to cause a selective coupling of modes by synthesizing the corresponding spatial spectrum of the disturbance and applying it to the fibre. It is therefore possible to choose the type of coupling that is desired to be favoured by creating a fibre disturbance corresponding to the corresponding synthesized spatial spectrum.

The means for synthesizing the spatial spectrum as a function of the mode(s) to be favoured are known and, regarding this topic, it will be useful to refer to any book about the theory of Fourier and/or to implement the software marketed as Matlab®.

Among the characteristics of the spatial spectrum, the amplitudes of these components as well as the frequencies thereof (more generally, the spectrum in the frequency domain) may be more particularly considered.

As for the amplitude of the spatial spectrum components of the disturbance, it determines the force of coupling between the modes and thus the effective attenuation length. If the signal is detected before having covered the greatest effective attenuation length amongst all the guided modes, a modulation of the disturbance amplitude causes a modulation of the energy of the signal detected at the exit of the disturbed segment of the guide.

It is to be noted that it is preferable to limit the length of the disturbance (and thus the length of the relief pattern in the tube) to the smallest effective attenuation length of the guided modes to establish a better efficiency of the loss modulation by the disturbance amplitude. The loss modulation by the disturbance amplitude modulates the amplitude of the spectrum components of the disturbance spatial spectrum but not their frequency.

As for the frequency of the spatial spectrum components of the disturbance, it may be considered the case of a monochromatic disturbance and the other cases in which the mono-chromatic spectrum may be known or not. It is to be noted that the loss modulation by the disturbance frequency modulates the frequency of the spectrum components of the disturbance spatial spectrum but not their amplitude.

In the case of a monochromatic disturbance, which is thus a disturbance whose spatial spectrum is reduced to only one component, the disturbance to be applied is sinusoidal, with a pitch or spatial period Λ. Such a disturbance favours the coupling between two modes of which the difference between the values of their respective propagation constants is equal to the norm of the special wave vector of the disturbance, namely 2π/Λ.

In the case of a disturbance with a determined spectrum, by choosing exactly which modes have to be coupled together by the disturbance, the required spectrum components can be determined that make it possible to synthesize the spatial spectrum of the disturbance and thus the shape thereof in space according to the theory of Fourier.

The case of a disturbance with an undetermined spectrum can be studied in a theoretical point of view, in particular by tools for analysing the impact of a disturbance whose spectrum is undetermined and known only by its statistical characteristics (average of the spectrum component values, standard deviation, length of correlation, etc.).

With reference now to the different natures of disturbances causing the mode coupling, it may be considered the mechanical disturbances and the thermal disturbances.

Among the mechanical disturbances, it may be considered the modulation due to micro-curvatures of the multimode fibre and the isotropic or anisotropic modulation of the multimode fibre diameter.

In practice, the transducer according to the invention consists of an optical fibre embedded in a disturbing medium referred to as the “surrounding medium”, said “surrounding medium” being patterned so as to apply to the surface or the volume of the fibre a disturbance with a determined spatial spectrum (amplitude and distribution in space).

As for a disturbance of the micro-curvature type, it is a curvature of the fibre in a plane containing its axis of propagation. Unlike a simple curvature often referred to as a “macro-curvature”, a micro-curvature is a disturbance and not a simple modification of the fibre at rest.

Indeed, the macro-curvature transforms the mode structure of the fibre, which means that the profile of these modes changes in a defined way, so that it can be said that the mode structure adapts in a way to the new position of the fibre. On a mathematical point of view, this modification is analysable, even if the modeling is made by first-order or second-order approximation of the exact solutions of the modes in the macro-curvature.

As for the micro-curvature, it is considered as a disturbance that does not modify the modeling of the mode structure (modes of the fibre at rest) but couples the modes together. Moreover, the micro-curvature disturbance is the most often understood as a succession of micro-curvatures all along the disturbed segment of the fibre. In practice, the coupling of the modes, which then become absorbent, reflects the fact that the mode structure of the fibre at rest has not the time to adapt to the successive changes of state (several micro-curvatures) of the fibre, and that they thus loose a part of their energy (they are absorbent) because this structure is not that of modes perfectly guided in the disturbed segment.

Actually, the shape of the micro-curvatures determines which spectrum components are present in the spatial spectrum of the disturbance and with which weights. Thus, the shape determines which modes are coupled, and the disturbance amplitude (to which the weights of the spectrum components are proportional) determines the force of the coupling between the modes actually coupled. The analysis of these spectrum components and their weights, i.e. the analysis of the micro-curvature spectrum, may be brought back to the analysis of the spectrum of the fibre curvature. The analysis of the micro-curvatures thus comes down to analysing the curvature of the micro-curvatures.

Therefore, this spectrum determines which mode groups are actually coupled and thus if the coupling is direct or indirect, or both simultaneously.

The modulation in the framework of the micro-curvature may be obtained under an effect of “movement” or an effect of “numerical aperture” of the multimode fibre.

As for the “movement” effect, two methods exist for modulating the energy of the guided signal between the entrance thereof into the disturbed segment and the exit thereof from this same disturbed segment.

If the length of the disturbed segment is shorter than the shortest of the effective lengths of the guided modes of the fibre, then each guided mode still transports energy at the exit of the disturbed segment. If the fibre fully conforms the shape of the micro-curvatures and only the amplitude of the micro-curvatures is modulated, then the force of coupling between the modes actually coupled, i.e. the weights of the spectrum components of the micro-curvatures (which weights are proportional to the amplitude of the micro-curvatures), are modulated, and accordingly the energy of the guided signal at the exit of the disturbed segment is proportionally modulated. It is a modulation through the amplitude of the spatial spectrum of the disturbance. This method requires a movement of the “surrounding medium” converging toward the axis of the fibre, in the plane of the micro-curvatures.

If the length of the disturbed segment is longer than the longest effective attenuation length of the guided modes of the fibre, the modes coupled together by the micro-curvatures loose all their energy before the guided signal exits from the disturbed segment. If the micro-curvatures are applied only progressively, i.e. the disturbance modulates the curvature spectrum of the position of the optical guide at rest (null curvature=infinite radius of curvature) up to a spectrum defined by the “surrounding medium” (fixed by this same medium), the micro-curvatures progressively increase the number of absorbent coupled modes from 1 to m, that is the rate of modes m/M whose energy is fully lost at the exit of the disturbed segment. Accordingly, the actual spectrum of the micro-curvatures modulates the energy of the guided signal between the entrance thereof into the disturbed segment and the exit thereof from this same disturbed segment. It is a modulation through the frequency of the spatial spectrum of the disturbance. This method also requires a movement of the “surrounding medium” converging toward the axis of the fibre, in the plane of the micro-curvatures.

Consequently, in the two above-described methods of using the micro-curvatures, it can be said that the modulation is obtained by the “movement” of the “surrounding medium”.

As for the “numerical aperture” effect, it is noticed that, by applying one or the other of the above-described “movement-based” methods of disturbing the micro-curvatures and by fixing the extent of the disturbance to a determined working point, it is still possible to modulate the energy of the guided signal between the entrance thereof into the disturbed segment and the exit thereof from this same segment by modulating the numerical aperture of the fibre.

Indeed, from the moment that the fibre is “movement-based” pre-disturbed by micro-curvatures, a variation of the refractive index of the fibre core due to a variation of a parameter of the environment (the measurand) different from the variation of the refractive index of the fibre optical cladding due to the same variation of a parameter of the environment (the measurand) results in a variation of the numerical aperture of the fibre and thus a variation of the coupling rate of the modes actually coupled, and consequently a modulation of the energy of the guided signal between the entrance thereof into the disturbed segment and the exit thereof from this same disturbed segment. A variation of the numerical aperture indeed means a structural change of the modes. Considered as a disturbance, the numerical aperture variation causes the coupling between the modes.

The difference of variation of the refractive indices between the core and the optical cladding is due to the difference of sensitivity of the refractive index to the parameter (the measurand) between the core and the optical cladding. The pre-disturbance by movement-based micro-curvatures leads the disturbed segment to the working point where the sensitivity of the energy losses of the guided signal to the variations of the numerical aperture is the highest.

The thermo-optic effects (variation of the refractive index as a function of the temperature) and elasto-optic effects (variation of the refractive index as a function of the stress induced by pressure or by deformation) are examples of effects enabling a parameter of the environment (the measurand) to modulate the numerical aperture of the fibre.

This method, which does not require any movement of the “surrounding medium” except the pre-movement, is thus a “numerical-aperture-based” method of modulation.

Now, as for the isotropic modulation of the diameters of the multimode fibre, it consists in a modulation of the transverse dimensions of the fibre, i.e. the dimensions of its cross section (which is the surface that is perpendicular to the axis of the fibre), and it modifies the transverse dimensions of the core. It also modifies the transverse dimensions of the fibre optical cladding, provided that the cladding is not the “surrounding medium” itself. It finally modifies the transverse dimensions of the fibre coating, in case such a coating exists. When all the diameters in the fibre cross-section (a diameter is understood as the distance separating two points on the contour of the core, the optical cladding or the coating, which are aligned with the centre of the fibre cross-section, this centre being itself defined by the intersection of the axis of the fibre with the cross section thereof) are modulated in length according to the same proportions and in phase (i.e. they increase or decrease together), the modulation is said to be isotropic in the cross section of the fibre. A practical example consists in modulating, all along the disturbed segment, the diameter of a circular cross-section fibre. Such a disturbance is referred to as an isotropic modulation of the fibre diameters.

The isotropic modulation of the fibre diameters is a disturbance of the fibre and causes, as in the case of the micro-curvatures, the coupling between the fibre modes, the latter then becoming absorbent. Accordingly, its spectrum determines which groups of modes are actually coupled and thus if the coupling is direct or indirect.

As in the micro-curvature case, regarding the isotropic modulation of the diameters, two “movement-based” methods exist for modulating the energy of the guided signal between the entrance thereof into the disturbed segment and the exit thereof from this same disturbed segment.
If the length of the disturbed segment is shorter than the shortest of the effective lengths of the guided modes of the fibre, then each guided mode still transports energy at the exit of the disturbed segment. If only the amplitude of modulation of the fibre diameters is modulated, then the force of coupling between the modes actually coupled, i.e. the weights of the spectrum components of the modulation (which weights are proportional to the amplitude of modulation of the fibre diameters), are modulated, and accordingly the energy of the guided signal at the exit of the disturbed segment is proportionally modulated. This method of modulation through the amplitude of the spatial spectrum of the disturbance requires a movement of the “surrounding medium” converging toward the axis of the fibre, all around the fibre.
If the length of the disturbed segment is longer than the longest effective attenuation length of the guided modes of the fibre, the modes coupled together by the modulation of the fibre diameters loose all their energy before the guided signal exits from the disturbed segment. If the pitch of modulation of the fibre diameters varies as a function of the parameter (the measurand), then the number of absorbent coupled modes from 1 to m, that is the rate of modes m/M whose energy is fully lost at the exit of the disturbed segment, also varies. Accordingly, the actual spectrum of the modulation of the fibre diameters modulates the energy of the guided signal between the entrance thereof into the disturbed segment and the exit thereof from this same disturbed segment. This method of modulation through the frequency of the spatial spectrum of the disturbance requires a movement, applied to the fibre, of the “surrounding medium” along the axis of the fibre and parallel thereto, but also a determined and pre-applied movement of the “surrounding movement” converging toward the axis of the fibre.

The two above-described methods of using the isotropic modulation of the fibre diameters operate based on the “movement” of the “surrounding medium”.

As in the micro-curvature case, regarding the isotropic modulation of the fibre diameters, one “numerical-aperture-based” method exists for modulating the energy of the guided signal between the entrance thereof into the disturbed segment and the exit thereof from this same disturbed segment.

Indeed, by applying one or the other of the “movement-based” methods of disturbing by the isotropic modulation of the fibre diameters and by fixing the extent of the disturbance to a determined working point, it is still possible to modulate the energy of the guided signal between the entrance thereof into the disturbed segment and the exit thereof from this same segment, this modulation being obtained by modulating the numerical aperture of the fibre.

Indeed, from the moment that the fibre is “movement-based” pre-disturbed by a modulation of its diameters, a variation of the refractive index of the fibre core due to a variation of the environment parameter (the measurand) different from the variation of the refractive index of the fibre cladding due to the same variation of the parameter (the measurand) results in a variation of the numerical aperture of the guide and thus a variation of the coupling rate of the modes actually coupled, and consequently a modulation of the energy of the guided signal between the entrance thereof into the disturbed segment and the exit thereof from this same disturbed segment. A variation of the numerical aperture indeed means a structural change of the modes. Considered as a disturbance, the numerical aperture variation causes the coupling between the modes.

The difference of variation of the refractive indices between the core and the cladding is due to the difference of sensitivity of the refractive index to the parameter (the measurand) between the core and the optical cladding. The pre-disturbance by the movement-based modulation of the fibre diameters leads the disturbed segment to the working point where the sensitivity of the energy losses of the guided signal to the variations of the numerical aperture is the highest.

The thermo-optic effects (variation of the refractive index as a function of the temperature) and elasto-optic effects (variation of the refractive index as a function of the stress induced by pressure or by deformation) are examples of effects enabling a measurand to modulate the numerical aperture of the fibre.

This method does not require any movement of the “surrounding medium” except the pre-movement and is thus a “numerical-aperture-based” method of modulation.

As for the modulation of the transverse dimensions of the fibre, i.e. the dimensions of its cross section (which is the surface that is perpendicular to the axis of the fibre), it modifies the transverse dimensions of the core. It also modifies the transverse dimensions of the fibre cladding, provided that the cladding is not the “surrounding medium” itself. It finally modifies the transverse dimensions of the fibre coating, in case such a coating exists. When all the diameters in the fibre cross-section are modulated in length according to different proportions and phases (i.e. they do not increase or decrease together), the modulation is said to be anisotropic in the cross section of the fibre. An example consists in modulating, all along the disturbed segment, the diameter of a circular cross-section fibre, by elongating it in a direction and reducing it in the perpendicular direction (elliptical contour), and doing the reverse in the same directions (rotation of the elliptical contour). Such a disturbance is referred to as an anisotropic modulation of the fibre diameters.

The anisotropic modulation is a disturbance of the fibre and causes, as in the preceding cases of disturbance, the coupling between the fibre modes, the latter then becoming absorbent. Accordingly, its spectrum determines which groups of modes are actually coupled and thus if the coupling is direct or indirect.

As regard the movement-based modulation, two other “movement-based” methods exist for modulating the energy of the guided signal between the entrance thereof into the disturbed segment and the exit thereof from this same disturbed segment.
If the length of the disturbed segment is shorter than the shortest of the effective lengths of the guided modes of the fibre, then each guided mode still transports energy at the exit of the disturbed segment. If only the amplitude of modulation of the fibre diameters is modulated, then the force of coupling between the modes actually coupled, i.e. the weights of the spectrum components of the modulation (which weights are proportional to the amplitude of modulation of the fibre diameters), are modulated, and accordingly the energy of the guided signal at the exit of the disturbed segment is proportionally modulated. This method of modulation through the amplitude of the spatial spectrum of the disturbance requires a movement of the “surrounding medium” converging toward the axis of the fibre, all around the fibre.
If the length of the disturbed segment is longer than the longest effective attenuation length of the guided modes of the fibre, the modes coupled together by the modulation of the fibre diameters loose all their energy before the guided signal exits from the disturbed segment. If the pitch of modulation of the fibre diameters varies as a function of the parameter (the measurand), then the number of absorbent coupled modes from 1 to m, that is the rate of modes m/M whose energy is fully lost at the exit of the disturbed segment, also varies. Accordingly, the actual spectrum of the modulation of the fibre diameters modulates the energy of the guided signal between the entrance thereof into the disturbed segment and the exit thereof from this same disturbed segment. This method of modulation through the frequency of the spatial spectrum of the disturbance requires a movement applied to the fibre by the “surrounding medium” along the axis of the fibre and parallel thereto, but also a determined and pre-applied movement converging toward the axis of the fibre, by the “surrounding movement”, all around the fibre.

The two above-described methods of using the anisotropic modulation of the fibre diameters operate based on the “movement” of the “surrounding medium”.

As regard the “numerical-aperture-based” modulation of the fibre, by applying one or the other of the “movement-based” methods of disturbing by the anisotropic modulation of the fibre diameters and by fixing the extent of the disturbance to a determined working point, it is still possible to modulate the energy of the guided signal between the entrance thereof into the disturbed segment and the exit thereof from this same segment.

Indeed, from the moment that the fibre is “movement-based” pre-disturbed by a modulation of its diameters, a variation of the refractive index of the fibre core due to a variation of the measurand different from the variation of the refractive index of the fibre cladding due to the same measurand results in a variation of the numerical aperture of the guide and thus a variation of the coupling rate of the modes actually coupled, and consequently a modulation of the energy of the guided signal between the entrance thereof into the disturbed segment and the exit thereof from this same disturbed segment. A variation of the numerical aperture indeed means a structural change of the modes. Considered as a disturbance, the numerical aperture variation causes the coupling between the modes.

The difference of variation of the refractive indices between the core and the cladding is due to the difference of sensitivity of the refractive index to the measurand between the core and the optical cladding. The pre-disturbance by the movement-based modulation of the fibre diameters leads the disturbed segment to the working point where the sensitivity of the energy losses of the guided signal to the variations of the numerical aperture is the highest.

The thermo-optic effects (variation of the refractive index as a function of the temperature),and elasto-optic effects (variation of the refractive index as a function of the stress induced by pressure or by deformation) are examples of effects enabling a measurand to modulate the numerical aperture of the fibre.

This method does not require any movement of the “surrounding medium” except the pre-movement and is thus a “numerical-aperture-based” method of modulation.

In the case of thermal disturbances, if the temperature of the optical fibre is locally modulated and according to a given pattern of temperature gradient all along the axis of the disturbed segment, the diameters of the fibre vary due to thermal extension. The refractive indices of the fibre core and cladding also vary. If moreover the refractive index variations dues to the thermal gradient are different between the fibre core and optical cladding (difference of sensitivity of the refractive index to the temperature between the core and the cladding), the numerical aperture varies. Finally, each slice of fibre has its own structure of guided modes, by either thermo-geometric or thermo-optic effect, indeed by a combination of both. There is then a coupling between the fibre modes. The spatial spectrum of the temperature gradient determines the nature of the coupling (direct or indirect).

If the thermal stretching of the fibre and the “surrounding medium” in the direction of the axis of the fibre is negligible, then a modulation of the thermal gradient amplitude modulates the force of the coupling between the modes actually coupled, i.e. the weights of the spatial spectrum components of the temperature gradient and accordingly modulates the energy of the signal between the entrance thereof into the disturbed segment and the exit thereof from this same segment, supposing that the length of the disturbed segment is shorter than the shortest effective attenuation length of the guided modes. This modulation thus operates based on the “numerical aperture”.

Finally, the case of mixed disturbances may be considered, corresponding to any disturbance combining several of the above-described disturbances that do not compensate for each other.

The functional implementation of the invention will now be described, which consists in embedding a segment of a fibre at rest that has to be disturbed in the “surrounding medium” (in practice, a tube enclosing the fibre), after said “surrounding medium” has been patterned, so that the latter applies to the surface or the volume of the fibre the desired disturbance with the spatial spectrum (amplitude and distribution in space), which depends on the value of the parameter to be measured (the measurand), so that the phenomenon of mode coupling that depends on the spatial spectrum of the disturbance is more or less important according to the variations of the measurand value.

Thus, the pattern of the tube enclosing the optical fibre is determined as a function of the modes to be coupled for the type of deformation anticipated and the parameter to be measured (in particular the way it will act on the tube, and thus on the fibre).

The choice of the “surrounding medium” material and the patterning thereof are determined, in particular, by:
the way the measurand acts on the “surrounding medium” (the sensitivity of the measurand “surrounding medium”),
the action the “surrounding medium” must have on the fibre, and
the type of mode coupling induced and stimulated by this action (with modulation of amplitude of the spectral components or with modulation of the spectral components themselves of the spatial spectrum, in direct coupling or indirect coupling).

In a preferential embodiment of the device for the functional implementation of the invention, the “surrounding medium” around the fibre is formed of two similar semi-cylinders, which are symmetrically united together so as to form a cylindrical tube with an inner diameter and an outer diameter. The inner surface of the two semi-cylinders is patterned by machining (with a mechanic tool or by laser machining) or by etching (chemical attack after masking, for example) so as to form the pattern of the mechanical disturbance that has to be applied to the fibre. The two semi-cylinders enclose the fibre and are welded together to form a tube around the fibre, said tube applying to the fibre the mechanical disturbance synthesized as desired. Alternatively to the welding, the two semi-cylinders are glued, crimped or clipsed together around the fibre. This mechanical disturbance is either a set of micro-curvatures, or an isotropic or anisotropic modulation of the fibre diameters. The pattern is determined beforehand by the synthesis of its spatial spectrum, according to whether the chosen mode of coupling is the direct mode or the indirect mode and also to whether the spatial spectrum modulation is operated based on the amplitude or the frequency and is induced by the movement or the numerical aperture.

The fibre segment enclosed by the tube formed by the two semi-cylinders, the inner surface of which is patterned, is the multimode optical fibre transducer. Such a transducer arrangement is the preferred general structure thereof.

This transducer general structure may be modified according to the parameter to which it is desired to be made sensitive and four examples will now be referred to: the sensitivity of the displacement of the “surrounding medium”, the sensitivity to the pressure of the “surrounding medium”, the longitudinal deformation of the “surrounding medium”, and the thermal expansion of the “surrounding medium”.

### Sensitivity to Displacement

The general structure of the transducer is modified so as to make it sensitive to the displacement of the two semi-cylinders toward each other. The mechanical disturbance is a set of micro-curvatures.

The two semi-cylinders, having patterned inner surfaces (patterned segments) and which are not fastened together, are extended by extensions of a certain length, and the inner surface of the extensions is not patterned (machined/etched) according to the pattern of the disturbance but forms a groove (or any other shape non-disturbing for the fibre) capable of receiving the fibre without disturbing it. Along a portion of these extensions, which are located on either side of the segments patterned according to the pattern of the disturbance, the thickness of one or each of the semi-cylindrical extensions is reduced to form two flexible girders adjacent to the segment patterned according to the pattern of the disturbance. Thus, thanks to the bent girders, the patterned segments may be caused to lean on the fibre, deforming the latter when they are subjected to a force, and be caused to come back to their initial position when the force exerted is cancelled, provided than the bending of the girders is produced in their domain of elasticity (out of the plastic domain). This condition is determined by the elasticity of the material, the thickness and the length of the girders, and finally their bending stroke. It is to be noted that the extensions, as indicated by their name, extend the structure and are not bridges over the two semi-cylinders.

The two semi-cylinders (patterned segments) enclose the fibre, and the ends of the extensions opposed to the patterned segments are welded together, wherein the extensions forming flexible girders are not fastened to their counterpart. In an alternative, the extensions exist on only one side of the semi-cylinders (patterned segments).

An example of semi-cylinder 1 is given in FIG. 1, with the patterned segment 2 including therein relief patterns 6. The patterned segment 2 is extended on each side, the axial/longitudinal direction, by girders 3 (or elastic tabs) and by actual extensions 4 comprising tabs 5 for their fixation to complementary tabs of the opposite semi-cylinder (not shown). The forces applied are radial forces and are schematized by thick arrows. These forces, illustrated in axial compression, may also be in axial traction (in the case where the fibre is pre-stressed at rest).

It is to be understood that the transducer results from the joining of two semi-cylinders 8 having a patterned inner face 6 and enclosing a multimode optical fibre 9, as shown in FIG. 3 in an exploded view.

If the fibre is straight between the two semi-cylinders, when no force is exerted on the semi-cylinders (no micro-curvature imparted to the fibre), any force exerted to the transducer in a perpendicular direction with respect to the axis of the tube (radial force) and of the micro-curvature and in the area of the segments machined according to the micro-curvature pattern brings the two similar-cylinders together and causes a curvature modulation of the micro-curvatures imparted to the fibre. It results therefrom a movement-based modulation of the guided signal between the entrance thereof into the disturbed segment and the exit thereof from this same disturbed segment.

In this implementation of the disturbance with micro-curvatures, the transducer is sensitive to the displacement, i.e. the displacement transmitted to the semi-cylinder(s) with its/their extensions (girders) by any mechanism, wherein said mechanism may possibly keep the other semi-cylinder still. The elasticity of the transducer in the direction perpendicular to the axis thereof being known, this transducer is also sensitive to the force.

### Pressure of the Surrounding Medium and in Particular Hydrostatic Pressure

The general structure of the transducer is modified so as to make it sensitive to the pressure exerted on the tube of the transducer. The mechanical disturbance is either a set of micro-curvatures, or an isotropic or anisotropic modulation of the fibre diameters.

If the disturbance implemented is a set of micro-curvatures, the fibre is micro-curved so that its curvature is that of the micro-curvatures of the pattern machined in the inner surface of the semi-cylinders, i.e. the fibre fully conforms the pattern of machining of the semi-cylinders.

In this case as in the case of an isotropic or anisotropic modulation of the fibre diameters, the fibre is movement-based pre-disturbed when the two semi-cylinders enclose it and are welded together. The tube therefore induces an initial rate of energy loss of the signal guided by the fibre, between the entrance thereof into the disturbed segment and the exit thereof from this same segment, and generates a distribution of initial stresses in the core, the cladding (if different from the “surrounding medium”) and the coating (if such coating exists) of the fibre.

The materials of the fibre core, cladding and coating and of the tube, as well as the thickness thereof, are all chosen so that any pressure exerted on the tube will be at least partially transmitted to the coating, the cladding and the core of the fibre. The materials of the fibre are also chosen so that they have distinct elasto-optic coefficients (distinct sensitivities of the refractive index, between the coating, the cladding and the core, to the pressure exerted on the material).

Accordingly, any pressure exerted on the transducer causes a numerical-aperture-based modulation of the guided signal between the entrance thereof into the disturbed segment and the exit thereof from this same segment. The initial amplitude of the disturbance is chosen so as to maximize the sensitivity of the numerical aperture to the variations of the exerted pressure.

However, if the choice of the materials and the amplitude of the pressure exerted on the transducer make the modulation through the amplitude of the disturbance spatial spectrum due to the compression of the tube non negligible, then the movement-based modulation of the guided signal is added to the numerical-aperture-based modulation.

### Longitudinal Deformation of the Surrounding Medium

The general structure of the transducer is modified so as to make it sensible to the longitudinal deformation exerted on the tube of the transducer along its axis of symmetry (longitudinal deformation). The mechanical disturbance is either a set of micro-curvatures or an isotropic or anisotropic modulation of the fibre diameters.

If the disturbance implemented is a set of micro-curvatures, the fibre is micro-curved so that its curvature is that of the micro-curvatures of the pattern machined in the inner surface of the semi-cylinders, i.e. the fibre fully conforms the pattern of machining of the semi-cylinders.

In this case as in the case of an isotropic or anisotropic modulation of the fibre diameters, the fibre is movement-based pre-disturbed when the two semi-cylinders enclose it and are welded together. The tube accordingly induces an initial rate of energy loss of the signal guided by the fibre, between the entrance thereof into the disturbed segment and the exit thereof from this same segment, and generates a distribution of initial stresses in the core, the cladding (if different from the “surrounding medium”) and the coating (if such coating exists) of the fibre.

The materials of the fibre core, cladding and coating and of the tube, as well as the thickness thereof and the length of the disturbed segment, are all chosen so that the tube has an apparent elasticity allowing it to be longitudinally deformed (along its axis of symmetry) by exerting a given force.

In this case, any longitudinal deformation modulates the disturbance spatial spectrum based on the frequency and the movement. It results therefrom that the energy of the guided signal is modulated between the entrance thereof into the disturbed segment and the exit thereof from this same segment.

An example of semi-cylinder 10 is given in FIG. 2 with the patterned segment 2 including therein relief patterns 6. The patterned segment 2 is extended on each side, the axial/longitudinal direction, by flanges (collars) 7 allowing axial/longitudinal forces to be applied thereto. The flanges 7 can comprise bored or taped holes (not shown). The patterned segment 2 comprises tabs 5 for their fixation to complementary tabs of the opposite semi-cylinder (not shown). The forces applied are axial forces and are schematized by thick arrows (compression or traction).

However, the materials of the fibre may also be chosen so that they have distinct elasto-optic coefficients (distinct sensitivities of the refractive index, between the coating, the cladding and the core, to the stress exerted on the material). If the choice of the materials and the amplitude of the deformation exerted on the transducer make the variation of the refractive index of the fibre core and the variation of the refractive index of the fibre cladding (these two variations being determined by the elasto-optic coefficients of each medium) non negligible and different from each other, then the modulation of the guided signal is operated based on the numerical-aperture. It is added to the frequency-based and movement-based modulation of the spatial spectrum, provided that it is not negligible, and replaces the latter if the latter is negligible.

In the case of a numerical-aperture-based modulation, the initial amplitude of the disturbance is chosen so as to maximize the sensitivity of the numerical aperture to the variations of the exerted pressure.

### Thermal Expansion of the Surrounding Medium

The general structure of the transducer is modified so as to make it sensible to the temperature surrounding the tube of the transducer. The mechanical disturbance is either a set of micro-curvatures or an isotropic or anisotropic modulation of the fibre diameters.

If the disturbance implemented is a set of micro-curvatures, the fibre is micro-curved so that its curvature is exactly that of the micro-curvatures of the pattern machined or etched in the inner surface of the semi-cylinders, i.e. the fibre fully conforms the pattern of machining of the semi-cylinders.

In this case as in the case of an isotropic or anisotropic modulation of the fibre diameters, the fibre is movement-based pre-disturbed when the two semi-cylinders enclose it and are welded together. The tube accordingly induces an initial rate of energy loss of the signal guided by the fibre, between the entrance thereof into the disturbed segment and the exit thereof from this same segment, and generates a distribution of initial stresses in the core, the cladding (if different from the “surrounding medium”) and the coating (if such coating exists) of the fibre.

The materials of the fibre core, cladding and coating and of the tube are all chosen so that the temperature surrounding the tube induces a longitudinal expansion of the tube. The tube accordingly exerts a longitudinal deformation on the fibre and then modulates the disturbance spatial spectrum based on the frequency and the movement. It results therefrom that the energy of the guided signal is modulated between the entrance thereof into the disturbed segment and the exit thereof from this same segment.

The material and thickness of the tube may also be chosen so that the thermal expansion of the tube in the plan of the cross section of the fibre is not negligible. The tube then exerts a pressure on the fibre and accordingly causes an amplitude-based modulation of the disturbance spatial spectrum, which modulates the energy of the guided signal between the entrance thereof into the disturbed segment ant the exit thereof of this same segment.

The materials of the fibre may finally be chosen so that they have distinct thermo-optic coefficients (distinct sensitivities of the refractive index, between the coating, the cladding and the core, to the temperature surrounding the material). In this case, the variations of temperature cause a modulation of the numerical aperture of the fibre. The energy of the guided signal is thus modulated between the entrance thereof into the disturbed segment and the exit thereof from this same segment. In practice, this numerical-aperture-based modulation is always added to the preceding ones and replaces them when the movement-based modulations are negligible.

The initial extent of the disturbance is chosen so as to maximize the sensitivity of the numerical aperture to the variations of temperature, if this modulation is used.

Accordingly, the choice of the transducer materials as a function of their properties (elasticity, thermal expansion, thermo-optic or elasto-optic coefficients), the choice of the dimensions of the tube, the fibre and the disturbed segment, the choice of the nature of disturbance and the type of mode coupling induced, are as many degrees of freedom that make it possible to make a transducer sensitive either to the surrounding temperature, or to the longitudinal deformation along its axis, or to the pressure/force/stress, or to the displacement.

The implementation of the invention will now be described.

The calculations and evaluations of magnitudes required for the making of a multimode optical fibre transducer are made within the framework of the coupling between (non evanescent) modes of an optical fibre, i.e. a (non magnetic) dielectric that is not very absorbent (without disturbance) and in the approximation of the low guidance. These calculations and evaluations are based on the theory established and the examples exposed by Dietrich Marcuse (Theory of Dielectric Optical Waveguides, Dietrich Marcuse, 2^{nd} edition, chapters 1-4, Academic Press Inc., ISBN 0-12-470951-6, 1991).

As explained above, according to whether it is chosen to modulate the transmission of the disturbed segment of the multimode optical fibre, i.e. the transducer, based on the movement and the amplitude or based on the movement and the spectrum, or even based on the numerical aperture, by direct coupling or by indirect coupling, by the action of micro-curvatures or the action of the isotropic variations of the fibre core diameter, or even the action of the anisotropic variations of the fibre core diameter (for example, variation of its ellipticity), different situations arise for the length of the disturbed segment, the amplitude of the disturbance and the spectrum thereof.

In particular, it is possible to deduce the length the transducer must either exceed (direct coupling), or not exceed (indirect coupling). Accordingly, the calculations performed according to the Marcuse theory regarding the coupling between two guided modes due, for example, to the isotropic variations of the fibre core diameter and an amplitude of the order of a few tenths of nanometres for an initial diameter of 5 μm (namely of the order of the percent of the initial diameter) result in a length of the order of the centimetre, for a total exchange of the energy of the fundamental mode LP₀₁ toward the neighbouring mode LP₀₂.

Likewise, an almost-total attenuation (more than 99% of energy loss) by coupling of the fundamental guide mode LP₀₁ of the same fibre to the more strongly coupled radiated mode for a same amplitude of disturbance of the optical fibre core diameter anticipates a length of several metres for the transducer. In both cases, the disturbance pitch optimizes the energy exchange, that it to say that the inverse thereof multiplied by 2π is equal to the difference between the propagation constants of the coupled modes. Disturbance amplitudes of the order of a few micrometres brought back the length of the transducer to a few millimetres for the total exchange of energy between the guided modes LP₀₁ and LP₀₂ and to a few centimetres for an almost-total loss of the energy of the fundamental guide mode LP₀₁ by energy exchange with the radiated mode that is the more strongly coupled therewith. The other total exchanges of energy between guided modes or one of the guided modes on the one hand and the whole of the radiated modes on the other hand, require transducer lengths a little bit longer but the orders of magnitude remain the same: a few millimetres between guided modes and a few centimetres between one of the guided modes and all the radiated modes. All this for disturbance amplitudes of a few percents of the diameter value of the non disturbed fibre and at optic wavelengths ranging from the visible to the near infrared.

In particular, the modulation of the signal by direct coupling and by spectrum-based modulation of a disturbance that consists, in the isotropic modulation of the fibre core diameter requires a transducer length of several centimetres (ranging for example from 5 cm to 10 cm according to the wavelength and the amplitude of the disturbance) so as to lose almost fully the energy of the guided modes then coupled to the radiated modes by the disturbance. This applies whether the modulation of the disturbance spectrum results from the movement (for example a longitudinal traction along the axis of the tube, which is the axis of the variations induced by the disturbance) or from the modulation of the numerical aperture.

The disturbance pitch that couples one of the guided modes of lower group-orders (m=0, 1, 2) to the nearest radiated modes (i.e. the nearest radiated modes in the space of the propagation constants with a constant slightly lower than k₀ n_{go}, where k₀ is the wave vector of the optical wave in vacuum and n_{go} is the refractive index of the fibre optical cladding) is of a few micrometres for an optical fibre having a numerical aperture of 0.5, a core diameter of 200 μm and excited to the wavelength of 630 nm. The disturbance pitch that couples one of the guided modes of higher group-orders (m=M, M−1, M−2, M: total number of groups of guided modes) to the nearest radiated modes is of a few hundredths of micrometres, or even a few millimetres for the same optical fibre.

Accordingly, the disturbance spectrum is synthesized as follows. The highest spatial frequency corresponding to the smallest pitch of disturbance required and the smallest spatial frequency corresponding to the greatest pitch of disturbance required are determined so that the number of guided modes coupled to the whole of the radiated modes is M−mᵢₙᵢ, for a disturbance that is at a determined point of action. The guided modes whose energy is thus lost are of group order of mᵢₙᵢ+1 to M. The spectrum is then the window of the spatial frequency components comprised between the lowest spatial frequency and the highest spatial frequency of the spectrum. By a transform of Fourier, the spatial frequency spectrum of the disturbance is translated into the ordinary space by an apodized oscillation with a pitch equal to the smallest pitch of the disturbance spectrum. The apodization rate (spreading of the disturbance in the ordinary space) is determined by the width in space of the spatial frequencies of the disturbance spectrum.

For example, an optical fibre whose core is made of glass (amorphous silica), with a core diameter of 200 μm, excited by an optical wave with a wavelength in vacuum of 630 nm and with a numerical aperture of 0.2, includes M=141 groups of guided modes. A variation of its core diameter with a spectrum of disturbance whose smallest pitch is 50 μm and greatest pitch is 8.535 mm couples the 100 modes of group order of 42 to 141. In order to respect the above-mentioned proportions for the transducer length and the disturbance amplitude at the core diameter, the disturbance amplitude is of the order of the micrometer for a transducer of a few centimetres long.

### Example of Pressure Transducer by Numerical Aperture Modulation

The pressure transducer is formed of an optical fibre with a core made of glass (amorphous silica) and an optical cladding made of doped glass. The mechanical cladding is preferably made of polyimide. The core diameter is 200 μm, the optical cladding diameter is of a few tenths of additional micrometres, for example 230 μm, and the mechanical cladding diameter is also of a few tenths of additional micrometres, for example 240 μm. It may be determined that an amplitude of isotropic disturbance of the fibre diameter of the order of 10 μm on the mechanical cladding results in a few micrometres on the fibre core. This value is deduced from the ratio of the elasticities each divided by the thickness of material the fibre core and claddings (stiffness per surface unit of the equivalent springs in each medium, in the radial direction of the fibre). According to the model used, the model of springs coupled in series, the amplitude of deformation of the code diameter is deduced from the amplitude of the disturbance directly applied to the mechanical cladding, as follows:

$${A}_{coeur} = \frac{\frac{{Y}_{go}}{{d}_{go} - {d}_{coeur}}}{\frac{{Y}_{coeur}}{{d}_{coeur}} + \frac{{Y}_{go}}{{d}_{go} - {d}_{coeur}}} \cdot \frac{\frac{{Y}_{gm}}{{d}_{gm} - {d}_{go}}}{\frac{{Y}_{gm}}{{d}_{gm} - {d}_{go}} + \frac{{Y}_{go}}{{d}_{go} - {d}_{coeur}}} \cdot {A}_{tube}$$

with the following values: Young's modulus of the core (glass) Y_{coeur}˜72 GPa, diameter of the core d_{coeur}=200 μm, Young's modulus of the optical cladding (doped glass) Y_{go}˜72 GPa, diameter of the optical cladding d_{go}=230 μm, Young's modulus of the mechanical cladding (polyimide) Y_{gm}˜2;5 GPa, and diameter of the mechanical cladding d_{gm}=240 μm, the amplitude of the disturbance inscribed in the tube, i.e. 30 μm, imparts at the fibre core a disturbance whose amplitude is ˜0.082×30=2.46 μm, namely 1.23% of the fibre core diameter without disturbance.

A transducer may be made of an aluminum tube with a 1 mm-thick wall and an etched inner face. The Young's modulus of aluminum is 75 GPa, namely of the same order of magnitude than that of glass and doped glass and higher than that of polyimide. In such a case, the transmission of the transducer is 29.08% (loss of the energy of 100 modes over a total of 141 guided modes).

When such a transducer is placed in a pressure field and the Young's modulus of the tube is not too high with respect to at least that of the fibre core material, a field of internal stresses extends through the whole body of the transducer from the outer surface of the aluminum tube to the centre of the fibre core. If it was not the case for the Young's modulus, the components of the stress tensor of the tube would be almost cancelled at the limit of the cylindrical inner surface thereof, so that the tube would not transmit any more stress to the different layers of the optical fibre. Accordingly, it is preferable that the Young's modules of the fibre (core and optical cladding) and of the hollow tube in which the fibre is place are close together. At the very least, the Young's modulus of the tube will be chosen so as not to be too high with respect to that of the fibre, at the risk of seeing a reduction of the transducer sensitivity, of seeing the transducer not to react to the modifications of its environment. Materials for the tube can thus be chosen as a function of the materials of the fibre, and conversely.

The variation of the field of internal stresses of the different materials of the fibre due to the variations of the internal stresses of the whole transducer, themselves due to the variations of the pressure field in which the transducer is placed, modulates by elasto-optic effect the refractive index of the core and the refractive index of the optical cladding of the fibre. The amplitude of this variation is not the same between the two mediums because the glasses are slightly different because of the doping. Finally, the numerical aperture of the fibre is modulated by the variations of the pressure field in which the transducer is located. The modulation is of the order of a few millimetres to a few centimetres according to the doping of the optical cladding and the modification of the elasto-optic coefficients with respect to those of the non-doped glass.

An increase of 1 hundredth of the numerical aperture causes an increase of the transmission of additional 16.87%, which leads it to 45.95% (loss of the energy of 80 modes over a total of 148 guided modes), which is perfectly detectable by a simple photo-detector circuit wired to transimpedance amplifier and amplifier. An increase of 1 thousandth of the numerical aperture causes an increase of the transmission of additional 1.42%, which leads it to 30.5% (loss of the energy of 98 modes over a total of 141 guided modes), which is a variation of the “small signal” type and which is still easily detectable thanks to synchronous modulation and demodulation techniques that have the advantage that they extract from the noise level the systematic and repeatable variations due to the variation of the measured pressure field.

### Example of Deformation Transducer by Movement-Based Spectrum Modulation

In this example, the structure of the pressure transducer by numerical aperture modulation is used without modification. Then, in the same conditions of coupling but with the smallest pitch of the disturbance spectrum led to a value of 45 μm, almost total optical losses are caused by direct coupling of all the guided modes of the fibre to the radiated modes (loss of the energy of all the guide modes) thus a transmission of 0%.

A variation of 3% of the transducer length and thus of the disturbance spectrum components (in terms of pitch) and thus of the smallest pitch of this spectrum then induces an increase of the transmission of additional 11.35% (loss of the energy of 125 modes over a total of 141 guided modes). An increase of 2% of the transducer length induces an increase of the transmission of additional 6.38% (loss of the energy of 132 modes over a total of 141 guided modes). Such variations are perfectly detectable by the above-described means.

### Example of Deformation Transducer by Numerical Aperture Modulation

In this example, the structure of the preceding deformation transducer by movement-based spectrum modulation is used, with replacement of the material of the optical cladding by PMMA of the same thickness (YPMMMA˜3.3 GPa) and the material of the mechanical cladding by Tefzel® of the same thickness (YTefzel˜0.8 GPa). The disturbance, having a smallest pitch of 30 μm and an amplitude of 30 μm, then induces a deformation of the core diameter of 2.96 μm, namely 1.48% of the initial core diameter. The transmission is then of 58.46% (loss of the energy of 64 modes over a total of 260 guided modes) for a numerical aperture of 0.37. With a transverse elasto-optic coefficient (along directions in the cross section of the fibre) of 0.27 in the core (Substrate-Strain-Induced tunability of Dense Wavelength-Division Multiplexing Thin-Film Filter, Rémy Parmentier and Michel Lequime, Optic Letters, vol. 28, n° 9, May 2003) et of 0.297 in the optical cladding (Strain and Temperature Sensitivity of a Single-Mode Polymer Optical Fibre, Manuel Silva-Lopez et al., Donghui Zhao et al., Optics Letters, vol. 30, n° 23, December 2005), a deformation of 5% results in a reduction of the transducer transmission of 0.71% (loss of the energy of 65 modes over a total of 258 guided modes) for a numerical aperture of 0.3669, knowing that the variation of the refractive index along the directions in the cross section of the fibre is effectively the index variation “seen” by the modes that propagate in the fibre. These variations of the “small signal” type are detectable and usable too as described above.

### Example of Temperature Transducer by Numerical Aperture Modulation

In this example, the structure of the deformation transducer by numerical aperture modulation is still used, but with a smaller pitch of the applied disturbance of 30 μm at ambient temperature. The transmission is then of 75.38% (loss of the energy of 64 modes over a total of 260 guided modes) for a numerical aperture of 0.37. Then, the thermo-optic coefficients of the fused silica and the PMMA being of 9.2 10⁻⁶ (Heterodyne Interferometric Measurement of the Thermo-Optic Coefficient of Single Mode fibre, Springfield chang and al., Chinese Journal of Physics, vol. 38, n^{o} 3-I, June 2000) and of −1.2 10⁻⁴ (Strain and Temperature Sensitivity of a Single-Mode Polymer. Optical Fibre, Manuel Silva-Lopez et al., Donghui Zhao et al., Optics Letters, vol. 30, n^{o} 23, December 2005), respectively, a variation of temperature of the transducer environment, transmitted to the whole body of the transducer, causes a variation of transmission of the fibre in the transducer.

Accordingly, a variation of temperature of 10° C. results in a variation of transmission of the transducer of additional 0.85% (loss of the energy of 63 modes over a total of 265 guided modes) for a numerical aperture of 0.3769. A variation of temperature of 50° C. results in a variation of transmission of the transducer of additional 4.55% (loss of the energy of 57 modes over a total of 284 guided modes) for a numerical aperture of 0.4033. A variation of temperature of 100° C. results in a variation of transmission of the transducer of additional 7.9% (loss of the energy of 51 modes over a total of 305 guided modes) for a numerical aperture of 0.4338. Such variations are detectable and usable too by the above-described means.

FIG. 4 shows an inner structure of a tube, whose pattern has been determined according to the methods of the present invention.

As it has been shown, the methods of optical signal modulation that can be implemented within the framework of the invention are the following:
micro-curvatures, isotropic modulation of the fibre radiuses, anisotropic modulation of the fibre radiuses,
direct coupling or indirect coupling of the modes,
spectrum-based or amplitude-based modulation,
movement-based or numerical-aperture-based modulation.

Within the framework of the invention, the preferential implementation is however the modulation of the light signal intensity by direct coupling of the guided modes to the radiated modes and by isotropic modulation or anisotropic modulation of the fibre diameters, whether this modulation is operated based on the spectrum or the amplitude, based on the movement or the numerical aperture. Indeed, in this case, the required transducer sensitivity is more easily achievable while preserving small size for the transducer, because the required dimensions for the relief of the inner surface of the hollow tube of the transducer are of the order of tenths to hundredths of micrometres. Preferably, the depth (or height) of the indentations of the relief pattern is at most of 100 μm unlike the conventional micro-curvatures in which deformations of the order of the mm are implemented. This makes it possible to make a transducer sufficiently sensitive, while preserving, on the one hand, its size, namely its length, and on the other hand, is diameter, and thus finally its volume. This criterion is decisive for measurements in those environments in which the space occupied by the transducer is a constraint.

The transducer of the invention, when inserted in appropriated transduction mechanisms, enables the measurement of numerous physical or chemical parameters.

1. An optical fibre transducer, said transducer being sensitive to at least one parameter of an environment in which it is placed, the modification of the parameter(s) resulting in a modification of at least one measurable characteristic of a light wave injected into the optical fibre and flowing through the transducer, the optical fibre being of the multimode type and including a means adapted so that the modification of the light-wave characteristic depends on a modification of mode coupling resulting from the modification of the environment parameter, the means leading to the mode coupling modification generating, upon the modification, a deformation of the fibre in the transducer according to a determined pattern,
characterized in that the means leading to the mode coupling modification is a hollow tube including therein a relief pattern and enclosing the optical fibre at the level of the transducer in a straight part of the fibre.

2. A transducer according to claim 1, characterized in that the deformation is a set of micro-curvatures generating a coupling of the fibre modes, without structural transformation of the fibre modes.

3. A transducer according to claim 1, characterized in that the deformation is a spatial modulation of the fibre diameter generating a coupling of the fibre modes, without structural transformation of the fibre modes.

4. A transducer according to claim 1, characterized in that the hollow tube including therein a relief pattern and enclosing the optical fibre at the level of the transducer applies a stress to said fibre at rest, said fibre being deformed according to the determined pattern at rest.

5. A transducer according to claim 1, characterized in that the hollow tube including therein a relief pattern and enclosing the optical fibre at the level of the transducer does not apply any stress to said fibre at rest, said fibre being not deformed at rest.

6. A transducer according to claim 1, characterized in that the tube is made of two longitudinal parts closing onto the fibre.

7. A transducer according to claim 6, characterized in that each longitudinal part comprises, at at least one of its two longitudinal ends, an extension acting as an elastic lever arm enabling the corresponding part to be brought back to a rest position in the absence of action from the environment parameter(s), said extension having no influence on the light-wave characteristics.

8. A transducer according to claim 7, characterized in that each longitudinal part comprises, at each of its two longitudinal ends, an extension acting as an elastic lever arm enabling the corresponding part to be brought back to a rest position in the absence of action from the environment parameter(s), said extension having no influence on the light-wave characteristics.

9. A transducer according to claim 1, characterized in that the tube is made of two longitudinal parts united and fastened together.

10. A transducer according to claim 1, characterized in that the environment parameter is chosen from one or more of the following possibilities:
force by deformation of the tube,
force by radial pressure or traction on the tube,
force by longitudinal pressure or traction on the tube,
temperature.

11. Method of making an optical fibre transducer, characterized in that, for a transducer according to claim 1 and having a relief pattern inside a hollow tube enclosing the fibre and modifying the coupling of guided and/or radiated modes as a function of at least one parameter acting by deformation on said transducer, the pattern is determined based on a spatial spectrum of disturbance as a function of the modes to be coupled for the type of deformation anticipated for the parameter to be measured.

12. A transducer according to claim 2, characterized in that the hollow tube including therein a relief pattern and enclosing the optical fibre at the level of the transducer applies a stress to said fibre at rest, said fibre being deformed according to the determined pattern at rest.

13. A transducer according to claim 3, characterized in that the hollow tube including therein a relief pattern and enclosing the optical fibre at the level of the transducer applies a stress to said fibre at rest, said fibre being deformed according to the determined pattern at rest.

14. A transducer according to claim 2, characterized in that the hollow tube including therein a relief pattern and enclosing the optical fibre at the level of the transducer does not apply any stress to said fibre at rest, said fibre being not deformed at rest.

15. A transducer according to claim 3, characterized in that the hollow tube including therein a relief pattern and enclosing the optical fibre at the level of the transducer does not apply any stress to said fibre at rest, said fibre being not deformed at rest.
